(19) United States
(12) Patent Application Publication
(10) Pub. No.: US 2023/0290381 A1
(43) Pub. Date: Sep. 14, 2023

(54) Autonomous Cognitive Audiovisual Editing System and Method

(71) Applicant: James Albert Ionson, Lexington, MA (US)

(72) Inventor: James Albert Ionson, Lexington, MA (US)

(21) Appl. No.: 17/690,967

(22) Filed: Mar. 9, 2022

(51) Int. Cl. G11B 27/031; G06V 20/40

(52) U.S. Cl. CPC G11B 27/031; G06V 20/41

(57) ABSTRACT

The disclosed autonomous cognitive audiovisual editing system and method is capable of cognitively analyzing captured audiovisual content including, but not limited to, video streams, audio streams and still images; and autonomously selecting editing features thereby eliminating the requirement that a user manually input information, such as a theme upon which editing is based. This is an important distinction from other “artificial intelligence” systems and methods which require, for example, manual selection of a video theme, which is not always compatible with the content of the captured audiovisual data. This invention utilizes cognitive processes and techniques of inference process algebras, symbolic emotional architectures, instinct-driven architectures and combinations thereof to enable autonomous cognitive editing of audiovisual data in a manner that emulates the ability of highly trained human directors and editors to make decisions based upon emotion and instinct combined with logical processing and reasoning.

This application claims the benefit of U.S. Provisional Application No. 61/159,370, filed Mar. 10, 2021, which is incorporated herein by reference in its entirety for all purposes.

### RELATED APPLICATIONS

The present application is related to United States patent number 9,189,137, issued Nov. 17, 2015, for METHOD AND SYSTEM FOR BROWSING, SEARCHING AND SHARING OF PERSONAL VIDEO BY A NON-PARAMETRIC APPROACH, by Oren Boiman and Alex Rav-Acha, included by reference herein.

The present application is related to U.S. Pat. No. 9,210,319, issued Dec. 8, 2015, for METHOD AND SYSTEM FOR CAPTURING IMPORTANT OBJECTS USING A CAMERA BASED ON PREDEFINED METRICS, by Alex Rav-Acha and Oren Boiman, included by reference herein.

The present application is related to U.S. Pat. No. 8,001,067 B2, issued Aug. 16, 2011, for METHOD FOR SUBSTITUTING AN ELECTRONIC EMULATION OF THE HUMAN BRAIN INTO AN APPLICATION TO REPLACE A HUMAN, by Thomas A. Visel, Vijay Divar, Lukas K. Womack, Matthew Fettig, Ilene P. Hamilton, included by reference herein.

The present application is related to U.S. Pat. No. 8,131,012, issued Mar. 6, 2012, for BEHAVIORAL RECOGNITION SYSTEM, by Eaton, et al., included by reference herein.

The present application is related to United States patent number 8,856,057, issued Oct. 7, 2014, for. COGNITIVE SECURITY SYSTEM AND METHOD, by James A. Tonson, included by reference herein.

The present application is related to U.S. Pat. No. 9,336,481 B1, issued May 10, 2016, for ORGANICALLY INSTINCT-DRIVEN SIMULATION SYSTEM AND METHOD, by James Albert Ionson, included by reference herein.

The present application is related to United States patent number 9,349,098, issued May 24, 2016, for COGNITIVE MEDICAL AND INDUSTRIAL INSPECTION SYSTEM AND METHOD, by James Albert Ionson, included by reference herein.

Other. Publications:

Alexander Rav-Acha and Oren Boiman, “Method. and System for Automatic Learning of Parameters for Automatic Video and Photo Editing Based on User's Satisfaction”, USPTO Publication #20150262615, Sep. 17, 2015.

Oren Boiman and Alexandeer Rav-Acha, “System and Method for Semi-Automatic Video Editing”, USPTO Publication #20150302894, Oct. 22, 2015.

John E. Lard and Shiwali Mohan, “A Case Study of Knowledge integration across Multiple Memories in SOAR”, Biologically Inspired Cognitive Architectures, April 2014, 8, pp. 93-99.

Alexander Rav-Acha and Oren Boiman, “Method and System for Automatic Generation of Clips from a Plurality of Images Based on an Inter-Objects Relationship Score”, USPTO Publication #20150131973, May 14, 2014.

Victor C. Hung and Avelino j. Gonzalez, “Towards a Human Behavior Model Based on Instincts”, Proceedings of BRIMS, 2007.

D. Canamero, “Modeling Motivations and Emotions as a Basis for Intelligent Behavior”, Prd. First Int. Symp. on Autonomous Agents, AA, The ACM Press, 1997.

A. R. Damasio, “Descartes' Error: Emotion, Reason and the Human Brain Robot”, New York, USA: Picador, 1994.

Eugene Eberbach, “Expressing Evolutionary Computation, Genetic Programming, Artificial Life, Autonomous Agents and DNA-Based Computing in $-Calculus—Revised Version”, August 2013.

Eugene Eberbach, “$-Calculus of Bounded Rational Agents: Flexible Optimization as Search under Bounded Resources in Interactive Systems”, FundamentaInformaticae 68, 47-102, 2005

Eugene Eberbach, “$-Calculus Bounded Rationality=Process Algebra+Anytime Algorithms”, Applicable Mathematics: Its Perspectives and Challenges, Narosa Publishing House, New Delhi, Mumbai, Calcutta, 532-539, 2001.

Euygen Eberbach and Shashi Phoha, “SAMON: Communication, Cooperation and Learning of Mobile Autonomous Robotic Agents, Proc. of the 11th IEEE. Conf. on Tools with Artificial Intelligence ICTAI'99, Chicago, Ill., 229-236, 1999.

Nils Goerke, “EMOBOT: A Robot Control Architecture Based on Emotion-Like Internal Values”, Mobile Robots, Moving Intelligence (ed J. Buchli). ARS/pIV, Germany, 75-94, 2006.

J. D. Velasquez, “When Robots Weep: Emotional Memories and Decision-Making”, Proc. 15th National Conference on Artificial Intelligence, AAAI Press, Madison, Wis., USA, 1997.

M. Salichs and M. Makfaz, “Using Emotions on Autonomous Agents. The Role of Happiness, Sadness and Fear.”, Adaptation in Artificial and Biological Systems (AISB'06), Bristol, England, 157-164, 2006.

John E. Laird, “The SOAR Cognitive Architecture”, MIT Press, May 2012.

Bradley J. Harnish, “Reactive Sensor Networks (RSN)”, AFRL-IF-RS-2003-245 Technical Report, Penn State University sponsored by DARPA and AFRL, 2003

Robert P. Marinier III and John E. Laird, “Emotion-Driven Reinforcement Learning”, http://sitemaker.umich.edu/marinier/files/marinier._laird_cogsci_2008_emotional.pdf

Ivaylo Popov and Krasimir Popov, “Adaptive Cognitive Method”, USPTO Publication #20140025612, January 2014.

Leonid I. Perlovsky, “Modeling Field Theory of Higher. Cognitive Functions”, Chapter III in “Artificial Cognition Systems, Eds. A. Loula, R. Gudwin, J. Queiroz. Idea Group, Hershey, PA, pp. 64-105, 2006.

Leonid I. Perlovsky and R. Kozma., Eds., “Neurodynamics of Higher-Level Cognition and Consciousness”, ISBN 978-3-540-73266 2, Springer-Verlag, Heidelberg, Germany, 2007.

Leonid I. Perlovsky, “Sapience, Consciousness, and the Knowledge Instinct. (Prolegomena to a Physical. Theory)”, In Sapient Systems, Eds. Mayorga, R, Perlovsky, L. I., Springer, London, 2007.

Patrick Soon-Shiong, “Reasoning Engines”, USPTO Publication #20140129504, May 2014.

Nikolaos Anastasopoulos, “Systems and Methods for Artificial Intelligence Decision Making in a Virtual Environment”, USPTO Publication #20140279800, September 2014.

Jitesh Dundas and David Chik, “Implementing Human-Like Intuition Mechanism in Artificial Intelligence”, http://www.arxiv.org/abs/1106.5917, Jun. 29, 2011.

Carios Gershenson, “Behaviour-based Knowledge Systems: An Epigenetic Path from Behaviour to Knowledge”, http://cogprints.org/2220/3/Gershenson-BBKS-Epigenetics.pdf.

Michael D. Byrne, “Cognitive Architectures in HCI: Present Work and Future Directions”, http://chil.rice.edu/research/pdf/Byrne_05.pd.f

### FIELD OF THE INVENTION

The present invention relates generally to machine behavior, and more specifically to autonomous cognitive editing of audiovisual data such as, but not limited to, video streams, audio streams, still images and combinations thereof, utilizing cognitive processes and techniques that emulate the ability of highly trained human directors and editors to make decisions based upon emotion and instinct combined with logical processing and reasoning.

### BACKGROUND OF THE INVENTION

The proliferation of digital imaging capture devices has resulted in an exponential growth of content intensive imaging data in the form of still images, video and audio. Unfortunately, much of this imaging data, although containing significant and relevant content, is not captured in a manner that enables efficient viewing and sharing. This problem has resulted in the introduction of numerous audiovisual editing applications designed to aid the average user in modifying their captured imaging data in a manner that results in an edited video which properly and efficiently represents the captured content in a more pleasing, exciting and efficient manner that is ready to be easily shared and enjoyed by others. Essential all of these applications axe manually intensive and extremely burdensome to the average user and require a great deal of time and effort to master and utilize properly. There have been recent attempts to simplify the editing process for average users such as disclosed in USPTO Publication #20150302894, “System and Method for Semi-Automatic Video Editing”, U.S. Pat. No. 9,189,137, “Method and System for Browsing, Searching and Sharing of Personal Video by a Non-Parametric Approach”, U.S. Pat. No. 9,210,310, “Method and System for Capturing Important Objects Using Camera Based on Predefined Metrics”, USPTO Publication #20150262615, “Method and System for Automatic Learning of Parameters for Automatic Video and Photo Editing Based on User's Satisfaction”, and USPTO Publication #20150131973, “Method and System for Automatic Generation of Clips from a Plurality of Images Based on an Inter-Objects Relationship Score”, all incorporated herein by reference in their entirety. Although these disclosures describe send automated video editing techniques, they still require the user to identify a basic theme for the video based upon content that the user feels are representative of the captured imaging data. Therefore, although the user is relieved of many tasks performed by an “Editor”, the user still serves in the role of “Director” and must guide and give manual instruction to the system such as the selection of a theme around which the video will be edited. Once the user selects a theme, these semi-automated video editing applications utilize rule based artificial intelligence to try and map selected portions of the captured imaging data into an edited video that matches rules based upon the selected theme. Although, these limited rules based artificial intelligence methods simplify the editing process to some degree, they still require critical manual inputs from the user regarding, for example, an appropriate theme to be used as the basis for editing; and quite often the user selected theme is not compatible with the content of the captured audiovisual data. This deficiency is responsible for the generation of edited videos that do not accurately reflect the nature of the captured imaging content, resulting in an edited video that is not acceptable to the user. Therefore, there is a need for a fully autonomous cognitive audiovisual editing system and method that utilizes cognitive techniques and processes which enable awareness of theme related content contained within audiovisual imaging data such as, but not limited to video streams, audio streams still images and combinations thereof; and be capable of emulating the abilities of highly skilled human directors and editors who are skilled at making decisions based upon emotion and instinct combined with logical processing and reasoning.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In accordance with the present invention, there is provided an autonomous cognitive audiovisual editing system and method for enabling autonomous cognitive editing of audiovisual data such as, but not limited to video streams, audio streams, still images and combinations thereof, in a manner that emulates the ability of highly skilled human directors and editors to make decisions based upon emotion and instinct combined with logical processing and reasoning. This invention comprises an autonomous cognitive video editing engine for autonomously converting audiovisual data such as, but not limited to, video clips, audio clips, still images and combinations thereof into a content-aware edited video by utilizing cognitive processes and techniques such as, but not limited to, symbolic emotional and instinct-driven architectures and inference processing algebras to enable autonomous cognitive editing of audiovisual data in a manner that emulates the ability of highly trained human directors and editors to make decisions based upon emotion and instinct combined with logical processing and reasoning (e.g., “The SOAR Cognitive Architecture”, “3-Calculus of Bounded Rational Agents”, “Using Emotions on Autonomous Agents. The role of Happiness, Sadness and Fear”, “EMOBOT: A Robot Control Architecture Based on Emotion-Like Internal Values” which are incorporated herein by reference in their entirety). Integral to the autonomous cognitive video editing engine is an audiovisual event detection module, for autonomously detecting, identifying and classifying events within video streams, audio streams, still images and combinations thereof which would trigger interest and emotional reaction if viewed by a human director: and editor. An autonomous video theme profile driver is incorporated into this invention for analyzing and characterizing detected audiovisual events and autonomously selecting an editing theme by utilizing cognitive processes and techniques emulate the emotional, instinctive, logical processing, reasoning and combinations thereof, abilities of humans. A video frame processor would then be utilized for the purpose of autonomously selecting as least one audiovisual frame associated with a video stream, audio stream, still images and combinations thereof, and processing the frame or frames in the context of an autonomously selected video theme by utilizing cognitive processes and techniques that emulate the emotional, instinctive, logical processing, and reasoning and combinations thereof abilities of humans. A pre-production video driver would then drive an interactive modification of audiovisual data to be further analyzed against detected audiovisual events characteristic of an autonomously selected video theme. The provided system and method for autonomously editing audiovisual data through the utilization of cognitive processes and techniques therefore results in the autonomous generation of a content aware edited video that is representative of an edited video prepared by highly skilled human directors and editors. This system and method greatly facilitate the management and sharing of captured audiovisual data without utilizing expensive professional human editors and/or the time consuming and often ineffective editing performed by typical consumers.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a block diagram of a semi-automatic audiovisual editing system that requires manual inputs from a human editor regarding choices related to the video theme of the edited audiovisual data; and

FIG. 2 is a block diagram of an autonomous cognitive audiovisual editing system that enables autonomous cognitive editing of audiovisual data such as, but not limited to, video streams, audio streams, still images and combinations thereof utilizing processes and techniques of inference process algebra, symbolic cognitive architectures, instinct-driven architectures and combinations thereof that emulate the ability of highly skilled human directors and editors to make decisions based upon emotion and instinct combined with logical processing and reasoning.

For purposes of clarity and brevity, like elements and components will bear the same designations and numbering throughout the Figures.

### DESCRIPTION OF THE PREFERRED EMBODIMENT

To provide an overall understanding certain illustrative embodiments will be described; however, it will be understood by one skilled in the art of cognitive processes and techniques such as, but not limited to, inference process algebra module 8 and symbolic emotional and instinct-driven architecture module 9 that the system and method described can be adapted and modified to provide systems and methods for other suitable applications and that additions and modifications can be made without departing from the scope of the system and method described herein.

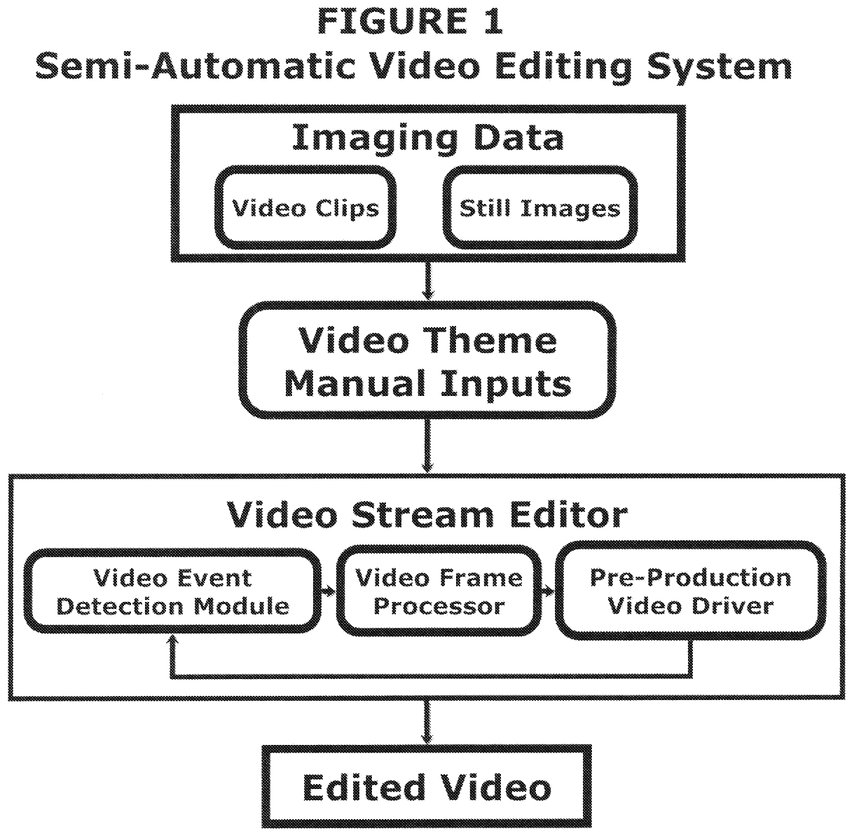

FIG. 1 is a block diagram of disclosed semi-automatic audiovisual editing systems that requires manual inputs from a user regarding choices related to the video theme of the edited audiovisual database 6 (e.g., “System and Method for Semi automatic Video Editing”; and “Method and System for Automatic Learning of. Parameters for Automatic Video and Photo Editing Based on User's Satisfaction” which are incorporated herein by reference in their entirety). Although these disclosures describe semi-automatic video editing techniques, they still require the user to identify a basic theme for the video based upon content that the user feels are representative of the captured audiovisual database 6. Therefore, although the user is relieved of many tasks performed by an “Editor”, the user still serves in the role of “Director” and must guide and give manual instruction to the system such as the selection of a theme around which the video will be edited. Once the user selects a theme, these semi-automatic video editing applications utilize rule based artificial intelligence to try and map selected portions of the captured audiovisual database 6 into an edited video 7 that matches rules based upon the selected theme. Although, these limited rules based artificial intelligence methods simplify the editing process to some degree, they still require critical manual inputs from the user regarding an appropriate theme to be used as the basis for editing; and quite often the user selected theme is not compatible with the content of the captured audiovisual database 6. This deficiency results in an edited video 7 that does not necessarily reflect the nature of the captured audiovisual content resulting in an edited video 7 that is not acceptable to the user. Therefore, there is a need for a fully autonomous cognitive audiovisual editing system and method that utilizes cognitive techniques and processes which enable awareness of theme related content contained within audiovisual database 6 such as, but not limited to video streams, audio streams still images and combinations thereof; and be capable of autonomously emulating the abilities of highly skilled human directors and editors that: make decisions based upon emotion and instinct combined with logical processing and reasoning.

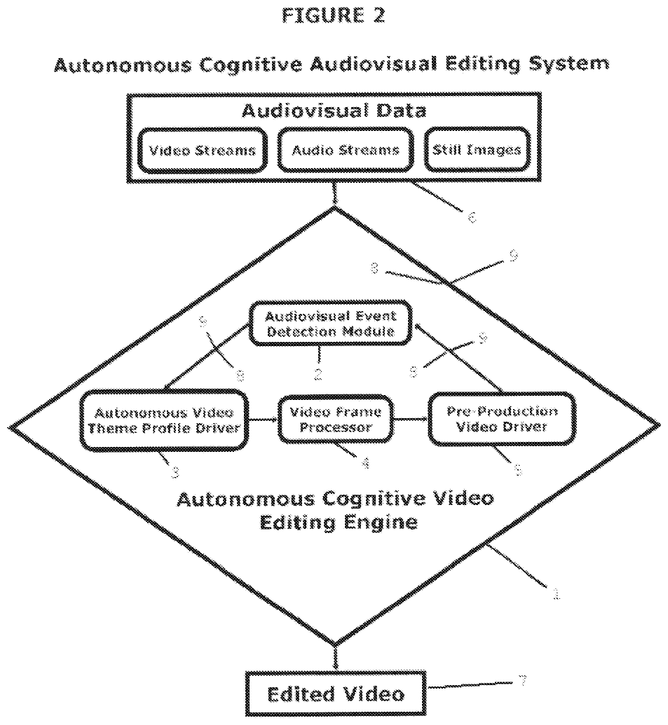

FIG. 2 is a block diagram of a fully autonomous cognitive audiovisual editing system that enables autonomous cognitive editing of audiovisual database 6 such as, but not limited to, video streams, audio streams, still images and combinations thereof by utilizing processes and techniques of an inference process algebra module 8, symbolic cognitive architectures, instinct-driven architectures and combinations thereof that emulate the ability of highly skilled human directors and editors to make decisions based upon emotion and instinct combined with logical processing and reasoning. This disclosed invention utilizes symbolic emotional and intuition-driven architectures (e.g., “Towards Behavior a Human Behavior Model Based on Instinct” which is incorporated herein by reference in its entirety) and inference process algebra module 8 such as, but not limited to, $-calculus (cost calculus) (e.g., “Expressing Evolutionary Computation, Genetic Programming, Artificial Life, Autonomous Agents and DNA-Based Computing in $-Calculus —Revised Version”; and “Towards a Human Behavior Model Based on Instinct” which are incorporated herein by reference in their entirety). These algebras and architectures have built-in cost optimization mechanisms allowing them to deal with non determinism, incomplete and uncertain information. In particular, $-calculus is a higher-order polyadic process algebra with a “cost” utility function, such as probability that enable autonomous agents to emulate human emotion, instincts and logical processing.

The innovative aspect of S-calculus techniques is that they integrate neural networks, symbolic cognitive, emotional and instinct-driven architectures, genetic programming/algorithms, symbolic rule-based expert systems, logic, imperative and object-oriented programming in a common framework (Expressing Evolutionary Computation, Genetic Programming, Artificial Life, Autonomous Agents and DNA-Based Computing in $-Calculus —Revised Version”, August 2013). These techniques have been successfully applied to the Office of. Naval research SAMON robotics testbed to derive GBML (Generic Behavior Message-passing Language) for behavior planning, control and communication of heterogeneous Autonomous Underwater Vehicles (AUV's) (e.g., SAMON: Communication, Cooperation and Learning of Mobile Autonomous Robotic Agents which is incorporated herein by reference in its entirety). In addition, $-calculus has also been used in the DARPA Reactive Sensor Networks Project at ARL Penn. State university for empirical cost profiling (e.g., “Reactive Sensor Networks (RSN)” which is incorporated herein by reference in its entirety) with $-calculus expressing all variables as cost expressions: the environment, multiple communication/interaction links, inference engines, modified structures, data, code and meta-code. An important feature of this disclosed invention is its internal value system which is designed to operate in accordance with psychological terms that humans associate with “drives” and “emotions”. These internal values do not actually realize real “drives” and “emotions”, but the invention operates in such a way that it exhibits behavior that is governed by “drives” and “emotions” in a manner that simulates the emotional, instinctive and logical thought processes of humans and responds to dynamic changes to audiovisual database 6 inputs just as humans might.

One component of this invention is an autonomous cognitive video editing engine 1 for autonomously converting an audiovisual database 6 such as, but not limited to, video streams, audio streams, still images and combinations thereof into a content-aware edited video 7 by utilizing cognitive processes and techniques of an inference process algebra module 2, symbolic emotional architectures, instinct-driven architectures and combinations thereof that emulate the emotional, instinctive, logical processing, reasoning, and combinations thereof, abilities of humans.

For example, the “emotional” state of the autonomous cognitive video editing engine 1 is strongly influenced by psychological internal values simulated by, for example, “happiness” and “pleasure” which are driven by inputted audio visual data analyzed by an audiovisual event detection module 2 which autonomously detects, identifies and classifies events within video streams, audio streams, still images and combinations thereof which would trigger interest and emotional reaction if viewed by a human director and editor. An autonomous video theme profile driver 3 then further analyzes these detected audiovisual events, and autonomously selects a video theme through additional utilization of cognitive processes and techniques of inference process algebra module 8, symbolic emotional architectures, instinct-driven architectures and combinations thereof in a manner that emulates the emotional, instinctive, logical processing, reasoning, and combinations thereof, abilities of humans. Once a video theme is autonomously selected, a video frame processor 4 autonomously selects and organizes at least one audiovisual frame associated with inputted audiovisual database 6 in the context of the autonomously selected video theme resulting in a pre-production video which is further analyzed by a pre-production video driver 5. The pre-production video driver 5 then enables iterative modifications of the pre-production video through iterative interactions with the audiovisual event detection module 2, autonomous video theme profile drive and the video frame processor 4 until the autonomous cognitive video editing engine 1 has achieved a maximum level of “happiness” and “pleasure” associated $-calculus techniques.

The output from the autonomous cognitive video editing engine 1 is an edited video 7 that represents the electronic audiovisual content of autonomously edited audiovisual database 6 through the use of content-aware cognitive processes and techniques that emulate the emotional, instinctive, logical processing, reasoning, and combinations thereof, abilities of humans.

A typical embodiment of this disclosed invention would result in an edited video 7 with Themes such as love, dance memories, business, fitness, selfies, party, sympathy, energetic activities to name a few with emphasis on Events such as facial expressions (smiles, frowns, crying, nervous behavior etc.); Environmental scenes such as outdoors, indoors, seaside, countryside etc.; and Behaviors such as running, dancing, jumping etc.; and Audio Patterns such as shouting, laughing, crying, musical beats etc.

Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Having thus described the invention, what is desired to be protected by Letters Patent is presented in the subsequently appended claims.

1. (canceled)

1. A non-transitory computer readable medium that stores instructions on a computerized system using $-calculus (cost calculus), cognitive processes and techniques of inference process algebras, symbolic emotional architectures, instinct-driven architectures and combinations thereof that emulate the emotional, instinctive, logical processing, reasoning, and combinations thereof, abilities of humans enabling, without user instructions, editing of audiovisual data such as, but not limited to video streams, audio streams, still images and combinations thereof, in a manner that emulates the ability of highly skilled human directors and editors to make decisions based upon emotion and instinct combined with logical processing and reasoning to:
Convert without user instructions audiovisual data such as, but not limited to, video streams, audio streams, still images and combinations thereof into a content-aware edited video by utilizing $-calculus (cost calculus) cognitive processes and techniques of inference process algebras, symbolic emotional architectures, instinct-driven architectures and combinations thereof that emulate the emotional, instinctive, logical processing, reasoning, and combinations thereof, abilities of humans;
detect, identify and classify events, without user instructions, within video streams, audio streams, still images and combinations thereof utilizing $-calculus (cost calculus) cognitive processes and techniques of inference process algebras, symbolic emotional architectures, instinct-driven architectures and combinations thereof which would trigger interest and emotional reaction as if selected by a professional human director and editor;
analyze and characterize detected audiovisual events; and without user instructions select an editing theme by utilizing $-calculus (cost calculus) cognitive processes and techniques of inference process algebras, symbolic emotional architectures, instinct-driven architectures and combinations thereof that emulate the emotional, instinctive, logical processing, reasoning, and combinations thereof, abilities of humans;
select, without user instructions, at least one audiovisual frame associated with a video stream, audio stream, still images and combinations thereof, and process the audiovisual frame or frames in the context of a computer selected video theme by utilizing $-calculus (cost calculus) cognitive processes and techniques of inference process algebras, symbolic emotional architectures, instinct-driven architectures and combinations thereof that emulate the emotional, instinctive, logical processing, reasoning, and combinations thereof, abilities of humans;
drive, without user instructions, a computerized modification of audiovisual data to be analyzed against computer detected audiovisual events characteristic of a computer selected video theme using $-calculus (cost calculus) cognitive processes and techniques of inference process algebras, symbolic emotional architectures, instinct-driven architectures and combinations thereof that emulate the emotional, instinctive, logical processing, reasoning, and combinations thereof, abilities of humans;
represent, without user instructions, an electronic display of audiovisual events that are recorded, edited, copied, viewed, shared, and combinations thereof.

2. (canceled)

2. The non-transitory computer readable medium that stores instructions on a computerized system according to claim 1, that without user instructions converts audiovisual data such as, but not limited to, video streams, audio streams, still images and combinations thereof into a content-aware edited video by utilizing $-calculus (cost calculus) cognitive processes and techniques of inference process algebras, symbolic emotional architectures, instinct-driven architectures and combinations thereof that emulate the emotional, instinctive, logical processing, reasoning, and combinations thereof, abilities of humans comprises a software autonomous cognitive video editing engine.

3. (canceled)

3. The non-transitory computer readable medium that stores instructions on a computerized system according to claim 1 that without user instructions detects, identifies and classifies events within video streams, audio streams, still images and combinations by utilization of $-calculus (cost calculus) cognitive processes and techniques of inference process algebras, symbolic emotional architectures, instinct-driven architectures thereof which would trigger interest and emotional reaction as if selected by a professional human director and editor comprises a software event detection module.

4. (canceled)

4. The non-transitory computer readable medium that stores instructions on a computerized system according to claim 1 that without user instructions characterizes detected audiovisual events; and selects an editing theme by utilizing $-calculus (cost calculus) cognitive processes and techniques of inference process algebras, symbolic emotional architectures, instinct-driven architectures and combinations thereof that emulate the emotional, instinctive, logical processing, reasoning, and combinations thereof, abilities of humans comprises a software video theme profile driver.

5. (canceled)

5. The non-transitory computer readable medium that stores instructions on a computerized system according to claim 1 that without user instructions selects at least one audiovisual frame associated with a video stream, audio stream, still images and combinations thereof, and processes the audiovisual frame or frames in the context of a computer selected video theme by utilizing $-calculus (cost calculus) cognitive processes and techniques of inference process algebras, symbolic emotional architectures, instinct-driven architectures and combinations thereof that emulate the emotional, instinctive, logical processing, reasoning, and combinations thereof, abilities of humans comprises a software video frame processor.

6. (canceled)

6. The non-transitory computer readable medium that stores instructions on a computerized system according to claim 1 that without user instructions drives interactive modifications of audiovisual data to be analyzed against detected audiovisual events characteristic of a computer selected video theme by utilizing $-calculus (cost calculus) cognitive processes and techniques of inference process algebras, symbolic emotional architectures, instinct-driven architectures and combinations thereof that emulate the emotional, instinctive, logical processing, reasoning, and combinations thereof, abilities of humans comprises a software pre-production video driver.

7. (canceled)

7. The non-transitory computer readable medium that stores instructions on a computerized system according to claim 1 that without user instructions represents an electronic display of audiovisual events that are recorded, edited, copied, viewed, shared, and combinations thereof comprises an audiovisual database.

8. (canceled)

8. The non-transitory computer readable medium that stores instructions on a computerized system according to claim 1 that without user instructions analyzes audiovisual data from video streams, audio streams, still images and combinations thereof using $-calculus (cost calculus) cognitive processes and techniques of inference process algebras, symbolic emotional architectures, instinct-driven architectures and combinations thereof that emulate the emotional, instinctive, logical processing, reasoning, and combinations thereof, abilities of humans comprise a software inference process algebra module.

9. (canceled)

9. The non-transitory computer readable medium that stores instructions on a computerized system according to claim 1 that without user instructions analyzes audiovisual data from video streams, audio streams, still images and combinations thereof using $-calculus (cost calculus), cognitive processes and techniques of inference process algebras, symbolic emotional architectures, instinct-driven architectures and combinations thereof that emulate the emotional, instinctive, logical processing, reasoning, and combinations thereof, abilities of humans comprise a software symbolic emotional and instinct-driven architecture module.

10. (canceled)

10. The non-transitory computer readable medium that stores instructions on a computerized system according to claim 1 that without user instructions represents the electronic audiovisual content of computer edited audiovisual data using utilizing $-calculus (cost calculus) cognitive processes and techniques of inference process algebras, symbolic emotional architectures, instinct-driven architectures and combinations thereof that emulate the emotional, instinctive, logical processing, reasoning, and combinations thereof, abilities of humans comprise an edited video.

11. (canceled)

11. A non-transitory computer readable medium that stores instructions on a computerized system using $-calculus (cost calculus), cognitive processes and techniques of inference process algebras, symbolic emotional architectures, instinct-driven architectures and combinations thereof that emulate the emotional, instinctive, logical processing, reasoning, and combinations thereof, abilities of humans enabling, without user instructions, editing of audiovisual data such as, but not limited to video streams, audio streams, still images and combinations thereof, in a manner that emulates the ability of highly skilled human directors and editors to make decisions based upon emotion and instinct combined with logical processing and reasoning to comprising:
a software cognitive video editing engine that without user instructions converts audiovisual data such as, but not limited to, video streams, audio streams, still images and combinations thereof into a content-aware edited video by utilizing $-calculus (cost calculus) cognitive processes and techniques of inference process algebras, symbolic emotional architectures, instinct-driven architectures and combinations thereof that emulate the emotional, instinctive, logical processing, reasoning, and combinations thereof, abilities of humans;
a software event detection module that utilizes $-calculus (cost calculus) cognitive processes and techniques of inference process algebras, symbolic emotional architectures, instinct-driven architectures and combinations thereof that emulate the emotional, instinctive, logical processing, reasoning, and combinations thereof, abilities of humans and without user instructions detects, identifies and classifies events within video streams, audio streams, still images and combinations thereof which would trigger interest and emotional reaction as if selected by a professional human director and editor;
a software video theme profile driver that without user instructions analyzes and characterizes detected audiovisual events; and without user instructions selects an editing theme by utilizing $-calculus (cost calculus) cognitive processes and techniques of inference process algebras, symbolic emotional architectures, instinct-driven architectures and combinations thereof that emulate the emotional, instinctive, logical processing, reasoning, and combinations thereof, abilities of humans;
a software video frame processor that without user instructions selects at least one audiovisual frame associated with a video stream, audio stream, still images and combinations thereof, and processes the audiovisual frame or frames in the context of an computer selected video theme by utilizing $-calculus (cost calculus) cognitive processes and techniques of inference process algebras, symbolic emotional architectures, instinct-driven architectures and combinations thereof that emulate the emotional, instinctive, logical processing, reasoning, and combinations thereof, abilities of humans;
a software pre-production video driver that without user instructions uses utilizing $-calculus (cost calculus) cognitive processes and techniques of inference process algebras, symbolic emotional architectures, instinct-driven architectures and combinations thereof that emulate the emotional, instinctive, logical processing, reasoning, and combinations thereof, abilities of humans to drive an interactive modification of audiovisual data to be analyzed against detected audiovisual events characteristic of an computer selected video theme;
an audiovisual database, for representing an electronic display of audiovisual events that are recorded, edited, copied, viewed, shared, and combinations thereof;
a software inference process algebra module, for analyzing audiovisual data from video streams, audio streams, still images and combinations thereof through the use of $-calculus (cost calculus) cognitive processes and techniques of inference process algebras, symbolic emotional architectures, instinct-driven architectures and combinations thereof that emulate the emotional, instinctive, logical processing, reasoning, and combinations thereof, abilities of humans;
a software symbolic emotional and instinct-driven architecture module, for analyzing audiovisual data from video streams, audio streams, still images and combinations thereof through the use of $-calculus (cost calculus) cognitive processes and techniques of inference process algebras, symbolic emotional architectures, instinct-driven architectures and combinations thereof that emulate the emotional, instinctive, logical processing, reasoning, and combinations thereof, abilities of humans;
a computer-generated edited video that without user instructions represents the electronic audiovisual content of computer edited audiovisual data using utilizing $-calculus (cost calculus) cognitive processes and techniques of inference process algebras, symbolic emotional architectures, instinct-driven architectures and combinations thereof that emulate the emotional, instinctive, logical processing, reasoning, and combinations thereof, abilities of humans

12. (canceled)

13. (canceled)
